(19) United States
(12) Patent Application Publication
(10) Pub. No.: US 2010/0205293 A1
(43) Pub. Date: Aug. 12, 2010

(54) COMPREHENSIVE POLICY FRAMEWORK FOR CONVERGED TELECOMMUNICATIONS NETWORKS

(75) Inventors: Q. James Hu, Sammamish, WA (US); Farooq Bari, Bothell, WA (US)

Correspondence Address: AT&T Legal Department - T&W;Attn: Patent Docketing, Room 2A-207, One AT&T Way, Bedminster, NJ, 07921, US

(73) Assignee: AT&T MOBILITY II LLC, Atlanta, GA (US)

(21) Appl. No.: 12/468,505

(22) Filed: May 19, 2009

Related U.S. Application Data
(60) Provisional application No. 61/151,139, filed on Feb. 9, 2009.
(60) Provisional application No. 61/159,664, filed on Mar. 12, 2009.

(51) Int. Cl. G06F 15/16; G06N 5/02

(52) U.S. Cl. 709/224; 709/223; 706/48

(57) ABSTRACT

The subject innovation relates to systems and/or methodologies for comprehensive policy based service delivery. A policy plane is provided as a comprehensive way to manage operator policies for most all IP and/or service flows (e.g., IMS and non-IMS) under varying network conditions, while keeping in view user preferences, user subscriptions, service requirements, terminal capabilities (e.g., including converged terminals), network capabilities (e.g., 3gpp and non-3gpp accesses inter-working with 3gpp), session transfer policies, service aware roaming, and so forth. The policy plane can be generated through harmonization of existing components (e.g., discussed infra), and creation of new policy aspects where desired (e.g., policies for identity and charging management in personal area network, etc.). The policy plane works to close gaps between standards, operator requirements, and user requirements.

### CLAIM OF PRIORITY UNDER 35 U.S.C. §119

This application claims priority to U.S. Provisional Application Ser. No. 61/151,139, filed on Feb. 9, 2009, entitled “POLICY ENHANCEMENTS” and U.S. Provisional Application Ser. No. 61/159,664, filed on Mar. 12, 2009, entitled “POLICY ENHANCEMENTS”, the entireties of which are incorporated herein by reference.

### TECHNICAL FIELD

The subject innovation relates generally to communication systems, and more particularly to apparatus and methodologies for comprehensive policy based service delivery.

### BACKGROUND

A number of service types can be provided through modern communication systems. For instance, a large number of communication systems can provide voice communication, data communication, and so forth. In addition, increased computing power available in wireless and handheld computing devices has led to an ever increasing spectrum of network data transmission. While the marketplace and availability of various communication methods and services has demonstrated rapid growth, the framework for managing these services has not necessarily kept pace.

Typically, communication service operators have employed somewhat ad-hoc management frameworks to implement a plurality of policies necessary for delivering communication services. However, communication networks support multiple services, such as messaging, voice, data, etc. These services can often overlap or be inter-dependent on one another from a delivery standpoint. These unstructured policy frameworks can lead to inefficiencies, and can make sharing policies between disparate providers unnecessarily difficult.

The current techniques for policy implementation are often inefficient, because they can lead to conflicting policies, or fail to make provisions for a plurality of useful policies. In addition, sharing of policies and preferences among service providers and networks can create additional inefficiencies, because of the lack of standardization among the networks. Consequently, it would be desirable to have a comprehensive and efficient technique for implementing and maintaining network communication policies.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its purpose is to present some concepts of the described embodiments in a simplified form as a prelude to the more detailed description that is presented later.

In accordance with one or more aspects and corresponding disclosure thereof, various aspects are described in connection with facilitating a comprehensive policy framework for converged telecommunications networks. According to related aspects, a system that facilitates network communication is provided. The system includes a communication network that provides communication services to a plurality of user devices. The system further includes a policy plane that obtains a service request from at least one user device, and determines a set of polices to be employed by the communication network in delivering the services.

Another aspect relates to a method for facilitating network communication. The method includes acquiring at least one service request from a user, obtaining at least one of service data, user data, or network data based on the service request, determining at least one policy based at least in part on one of the service request, user data, service data, or network data; and providing a set of customized services to the user by implementing the policies.

Yet another aspect relates to a system facilitating network communication. The system includes means for obtaining at least one service request from at least one of a user or a user device, means for acquiring at least one of service data, user data, or network data based on the service request, means for determining at least one policy based at least in part on one of the service request, user data, service data, or network data, and means for providing a set of customized services to the user by implementing the policies.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates a general component block diagram of an example telecommunications network in accordance with an aspect of the subject specification.

FIG. 2 illustrates an example block diagram of a communication system in accordance with an aspect of the subject specification.

FIG. 3 illustrates an example policy component in accordance with an aspect of the subject specification.

FIG. 4 illustrates an example policy set in accordance with an aspect of the subject specification.

FIG. 5 illustrates an example block diagram of a communication system in accordance with an aspect of the subject specification.

FIG. 6 illustrates an example methodology for policy enhancement in accordance with an aspect of the subject specification.

FIG. 7 illustrates an example methodology for policy conflict resolution in accordance with an aspect of the subject specification.

FIG. 8 illustrates a system that employs an artificial intelligence component which facilitates automating one or more features in accordance with the subject specification.

FIG. 9 illustrates a wireless communication system in accordance with an aspect of the subject specification.

FIG. 10 illustrates an example wireless communication system in accordance with an aspect of the subject specification.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident; however, that such matter can be practiced without these specific details. In other instances, well-known structures and devices are shown in block diagram form in order to facilitate describing the claimed subject matter.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

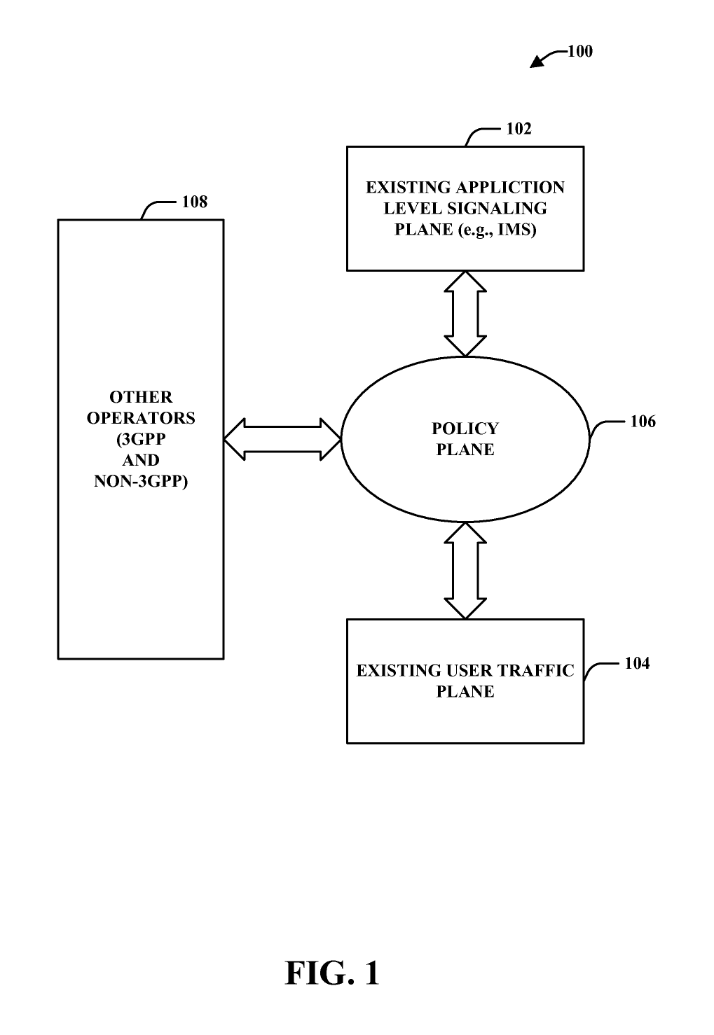

Referring initially to FIG. 1, a general component block diagram illustrating an example telecommunications network is shown in accordance with an aspect of the current innovation. The telecommunications network 100 includes an existing application level signaling plane 102, an existing user traffic plane 104, a policy plane 106, and a set of other operators (e.g., 3GPP and Non-3GPP) 108. The policy plane 106 is a comprehensive way to manage operator policies for most all IP and/or service flows (e.g., IMS and non-IMS) under varying network conditions, while keeping in view user preferences, user subscriptions, service requirements, terminal capabilities (e.g., including converged terminals), network capabilities (e.g., 3gpp and non-3gpp accesses inter-working with 3gpp), session transfer policies, service aware roaming, and so forth. The policy plane 106 can be generated through harmonization of existing components (e.g., discussed infra), and creation of new policy aspects where desired (e.g., policies for identity and charging management in personal area network, etc.). The policy plane 106 works to close gaps between standards, operator requirements, and user requirements.

A plurality of embodiments are possible for implementing the policy plane 106. For example, the policy plane 106 can be realized as an additional layer appended to an existing policy server. Additionally or alternatively, the policy plane 106 can reside in a policy charging and resource function (PCRF). It is to be appreciated that these are but a few examples; and those skilled in the art will be able to readily identify additional implementations that are within the scope and spirit of the current innovation. For example, a telecommunications network is illustrated for brevity and simplicity of explanation; however those skilled in the art will appreciate that the policy plane 106 can be implemented in most any communication network.

Typically, current policy frameworks are limited to internet protocol (IP) flow controls. However, there are a host of other mobile services that can be provided in the telecommunications network 100, including but not limited to messaging, service, and so forth. In accordance with the current innovation, the policy plane 106 can obtain, receive, or otherwise acquire intelligence (e.g., location, time, etc.) from a communication network (e.g., telecommunications network 100), and use the intelligence alone or in combination with one or more policies to determine or facilitate user services (discussed infra).

The policy plane 106 can facilitate interaction between the existing application level signaling plane 102 (e.g., IMS), the existing user traffic plane 104, and the other operators 108. For instance, a user being serviced by a first operator's network may roam to a second operator's network. In order to provide the user's services, the second operator may desire to know what the user is provisioned for, what the user's services are, and so forth. The first service provider's policy plane 106 can exchange the desired information with the second provider. As a result, the second provider can accept the policies governing the user's service, and provide roaming service to the user based on the policies. Conversely, the second provider can reject the policies associated with the user, and/or refuse service to the user.

As an additional example, the existing application level signaling plane 102 can be an IP Multimedia Subsystem (IMS), which is an architectural framework for delivering internet protocol (IP) multimedia services. The policy plane 106 can facilitate the delivery of IP services based at least in part on one more policies. The policies can include, but are not limited to user defined policies, quality of service (QoS) policies, charging policies, access network selection policies, mobility protocol selection policies, IMS/CS domain selection policies, service selection policies, privacy policies, ID management policies, and so forth (discussed infra). In addition, the policy plane 106 can leverage external packet inspection in the policy management framework. For instance, packet inspection can act as a policy enforcement point, and needs to sit in the traffic flow. Additionally or alternatively, packet inspection could act as a policy decision point and monitor flows via a tap.

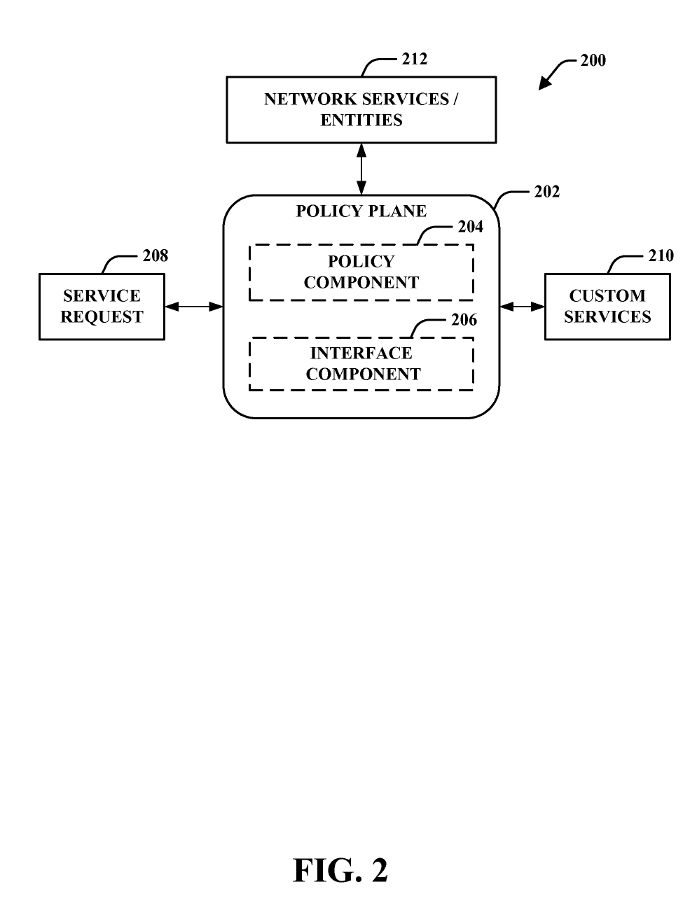

Turning to FIG. 2 an example block diagram illustrating a communication system is shown in accordance with an aspect of the subject innovation. The communication system 200 includes a policy plane 202. As previously discussed, the policy plane 202 is a comprehensive solution for handling operator policies regarding most all internet protocol (IP) and/or service flows (e.g., IMS and non-IMS) under varying network conditions. In addition, the policy plane 202 can monitor, track, or otherwise account for user preferences, user subscriptions, service requirements, terminal capabilities (e.g., including converged terminals), network capabilities (e.g., 3gpp and non-3gpp accesses inter-working with 3gpp), session transfer policies, service aware roaming, and so forth.

The policy plane 202 includes a policy component 204, and an interface component 206. The policy component 204 can create, manage, and/or manipulate one or more policies. In addition, the policy component 204 can be responsible for policy provisioning (e.g., including syntax checking), policy parsing, policy cataloging, and so forth. Furthermore, the policy component 204 can be responsible for policy conflict resolution, precedence setting, service level agreement (SLA) management, and most any other policy related functions that are deemed important by service providers. For example, a user's service may include the ability to place calls in foreign countries, but not the ability to send text messages. The policy component 204 can provide mechanisms for dynamic SLA management that enables the user or service provider to negotiate (e.g., with one or more partners) for the desired service (e.g., text messaging).

The policy plane 202 also includes an interface component 206, which provides various adapters, connectors, channels, communication paths, etc. to integrate the policy plane 202 into virtually any communication, operating, and/or database system(s). In addition, the interface component 206 can provide various adapters, connectors, channels, communication paths, etc., that provide for interaction with the policy plane 202. In particular, the interface component 206 can obtain most any data relating to a device that is associated with a communication process in a communication network. For example, the interface component 206 can acquire data regarding a user or devices network services (e.g., user data), including but not limited to account information, user identifications, service subscriptions, and so forth. The user data can be employed by the network to monitor the user's network activity, such as calls placed, network resources consumed, and so forth. In addition, the interface component 206 can acquire data related to a requested service and/or network properties (e.g., network data). The network data can include information such as time, date, location, and most any other information maintained or determined by the network that is relevant to delivery of one or more services.

By way of example, in operation the interface component 206 can receive one or more service requests 208 from a device associated with a communication network. Examples of associated devices include but are not limited to mobile phones, laptops, PDAs, smart phones, GPS devices, desktops, portable media devices, and so forth. In addition, the interface component 206 can obtain virtually any associated user data and/or network data pertaining to the requested services. For instance, the interface component 206 can acquire a request for a service from a user, and based on the request the interface component 206 can acquire, locate, or otherwise determine one or more user data elements and/or network data elements relating to the service request and/or user.

The interface component 206 can communicate the service request 208 and related data to the policy component 204, wherein the policy component 204 can obtain, locate, or otherwise determine one or more policies based on the service request 208 and the associated device. As mentioned previously, the policies can include but are not limited to user defined policies (e.g., preferences), quality of service (QoS) policies, charging policies, access network selection policies, mobility protocol selection policies, IMS/CS domain selection policies, service selection policies, privacy policies, ID management policies, and so forth. Based on the policies, network data, and the service request 208, the policy plane 202 can provide a set of customized services 210. For instance, the policy plane 202 can obtain a service request 208 from an associated mobile device (e.g., via the interface component 206) to access the internet. The policy component 204 inspects one or more policies, and determines that the mobile device does not have internet access included in its service. Furthermore, the policy component 204 can determines the appropriate charging policy. The policy plane 202 can provide the mobile device with a set of custom services 210 that enable it to access the internet, and charge the mobile device for the access based on the appropriate charging policy.

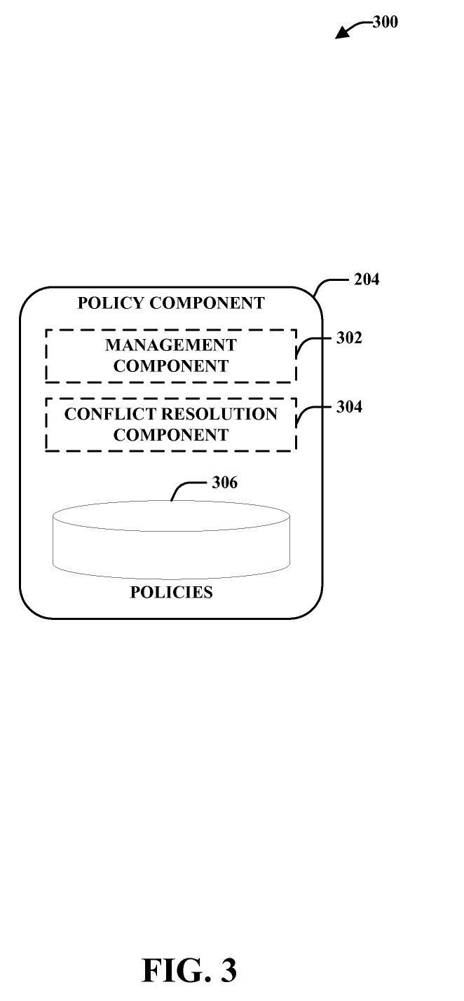

FIG. 3 illustrates an example policy component in accordance with an aspect of the subject innovation. The policy component 204 includes a management component 302, a conflict resolution component 304, and a set of policies 306. The management component 302 enables the policy component 204 to locate, create, manipulate, and/or organize one or more policies (discussed supra). For example, the management component 302 can identify or locate one or more polices related to a service request by a user. In addition, the management component 302 can update or modify the policies as necessary.

The conflict resolution component 304 can identify one or more conflicting policies, and implement one or more strategies to resolve said conflict. Policy conflicts can occur based on a plurality of factors, for example, different network entities may inadvertently enter conflicting policies for a user or service. The conflict resolution component examines, investigates, or otherwise analyzes the contents or details of policies identified as conflicting to determine the nature or source of the conflict. In accordance with an aspect, one mechanism the conflict resolution component 304 can employ to resolve conflicting polices is prioritization. Prioritization involves the conflict resolution component 304 ranking based on primacy of the conflicting policies. For example, a conflict can be determined between a first policy and a second policy. A prioritization value can be determined for each of the first and second policy. The prioritization value can be most any suitable indicator for assigning, ranking, or prioritizing the policies. For example, the prioritization value can be a numeric indicator based on a predetermined scale, a grade, a ranking, and so forth. In addition, the prioritization value can be associated with the policy in virtually any suitable manner, such as included in the policy, appended to the policy, a tag, metadata, etc. Additionally or alternatively, the prioritization value can be dynamically determined by the conflict resolution component 304 based on one or more features of the policy. For example, the prioritization value for each of the first and second policies can be determined based on the creators of the policies.

The conflict resolution component 304 can resolve the conflicts based on the determined prioritization values. Returning to the previous example, the conflict can be resolved by applying the second policy, where the second policy has a higher prioritization value than the first policy. Additionally, or alternatively the conflict resolution component 304 can settle conflicts based on one or more policies. For instance, the conflict resolution component 304 can apply the first policy, based on a conflict resolution policy indicating the first policy should always be applied when there is a conflict between a first policy and a second policy. In addition, the conflict resolution component 304 can determine one or more precedence based at least in part on settlements. For example, a precedent can be determined that allows for future conflicts involving the first policy and second policy to be settled according to the previous solution.

The polices 306 can be maintained in virtually any suitable manner. While, the polices are illustrated as being included in the policy component 204, it should be noted that the implementation is not so limited. For example, the polices can be maintained in a data store that is communicatively connected to the policy component 204. Additionally or alternatively, the policies 306 can be distributed throughout the communication network (See FIG. 1 and 2). It is to be appreciated that the foregoing represents but a few examples illustrated for brevity and clarity of explanation; however, multiple equivalent techniques are possible within the scope and spirit of the subject innovation.

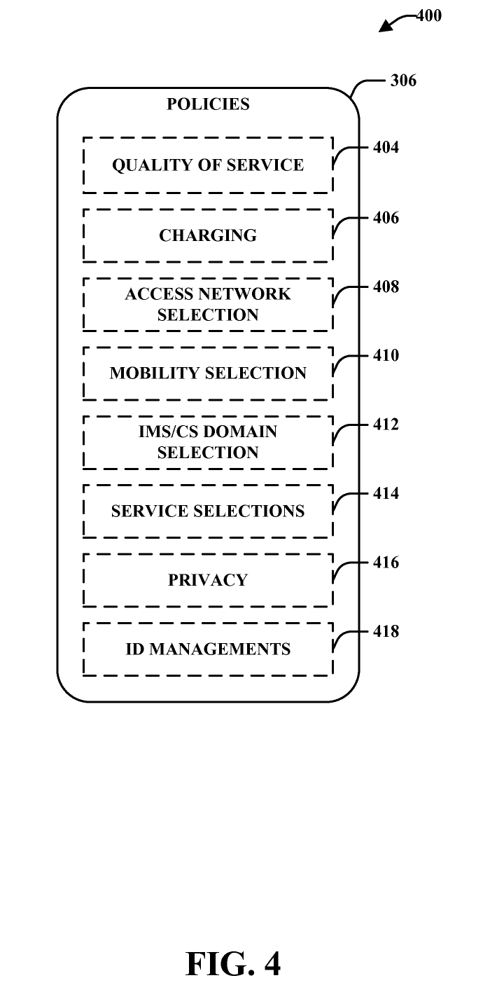

Turning now to FIG. 4, an example set of policies are illustrated in accordance with an aspect of the subject innovation. The policies 306 include a set of quality of service (QoS) policies 404. The QoS policies 404 provide different priority levels to different applications, users, or data flows, or to guarantee a certain level of performance to a data flow. For example, the QoS policies 404 can dictate that a user is guaranteed a certain bit-rate (e.g., 400 Kbs), and has certain delay requirements, etc. based on the users subscription terms.

In addition, the policies 306 include a set of charging policies 406. The charging policies 406 layout the manner and/or mechanisms for billing, crediting, or debiting a user account for services provided. For example, the charging policies can be used to determine the price charged to a user for roaming calls based on their service subscription. The charging policies 406 can be based on a plurality of triggers. For example, the charging policies 406 can be time based, wherein users are charged based on the time of service usage, such as making a call during peak hours or non-peak hours. Additionally or alternatively, the charging policies can be event based or volume based. For example, where a user is allotted a certain volume of data transmission per month (e.g., 5 MB/month) a volume based charging policy 406 can track the users data usage, and determine how much the user is to be charged upon exceeding their monthly allotment (e.g., 10 cent for each additional Kb). Additionally, an event based charging policy can detail how much a user is to be charged based on a certain event. For example, a user may be charged for each email sent or received.

Furthermore, the policies 306 can include a set of access network selection policies 408, and a set of mobility selection policies 410. The mobility selection policies 410 can detail the different types of mobility (e.g., 3gpp, CDMA, etc.), and can determine a user's mobility based on their service subscription or most any of a plurality of additional factors. A set of internet protocol based domain (IMS)/circuit switched domain (CS) selection policies 412 included in the policies 306 can facilitate determinations of which domain a user or mobile device should be currently using, as well as mechanism for transferring communications from one domain to the other.

Moreover, the policies 306 can include sets of service selection policies 414, privacy policies 416, and identification (ID) management policies 418. It can be readily appreciated that the policies (e.g., policies 404-418) maintained by the policies 306 can be inter-related. By way of example, the charging policies 406, mobility selection policies 410, or service selection policies 414 can impact the quality of service polices 404. In addition, if there are conflicts between one or more policies, the policy component 204 can resolve the conflicts based on policy prioritization.

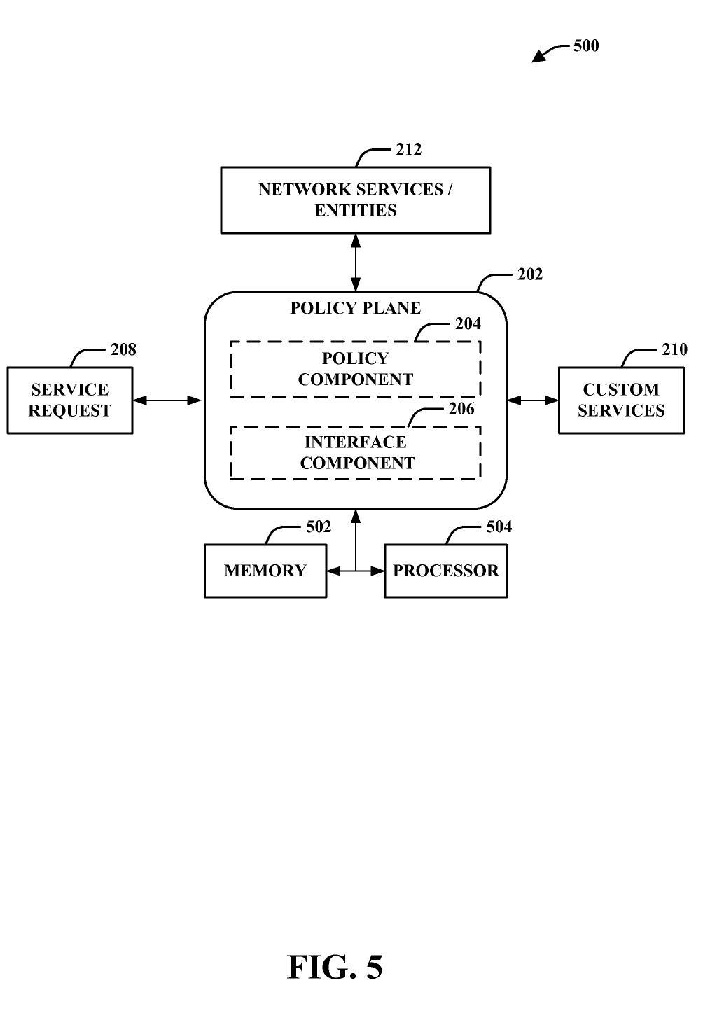

FIG. 5 illustrates an example block diagram of a communication system in accordance with an aspect of the subject innovation. The system 500 includes a policy plane 202 that is a comprehensive way to manage operator policies for most all IP and/or service flows (e.g., IMS and non-IMS) under varying network conditions, while keeping in view user preferences, user subscriptions, service requirements, terminal capabilities (e.g., including converged terminals), network capabilities (e.g., 3gpp and non-3gpp accesses inter-working with 3gpp), session transfer policies, service aware roaming, and so forth. As discussed previously, the policy plane 202 includes a policy component 204 that can create, manage, and/or manipulate one or more policies, including but not limited to prioritization of policies, policy conflict resolution, and policy precedence setting.

System 500 can additionally comprise memory 502 that is operatively coupled to the policy plane 202 and that stores policies, policy prioritizations, policy precedence, and so forth or information related to the policies, policy prioritizations, policy precedence, and any other suitable information related to facilitating policy enhancements. A processor 504 can be operatively connected to the policy plane 202 (and/or memory 502) to facilitate storing and/or communicating content and the like. It is to be appreciated that processor 504 can be a processor dedicated to implementing policies, analyzing policies, prioritizing policies and/or setting policy related precedence, a processor that controls one or more components of system 500, and/or a processor that implements policies, analyzes policies, prioritizes policies and/or sets policy related precedence, and controls one or more components of system 500.

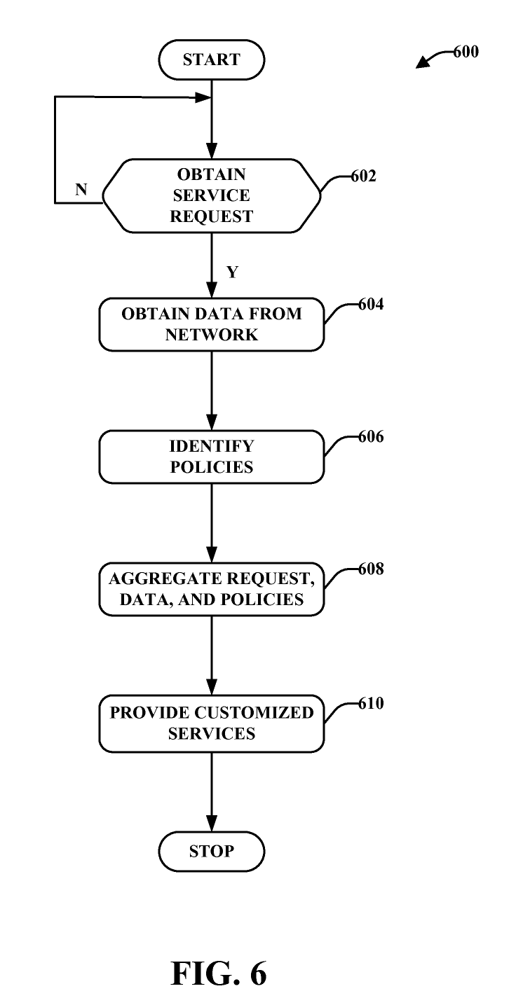

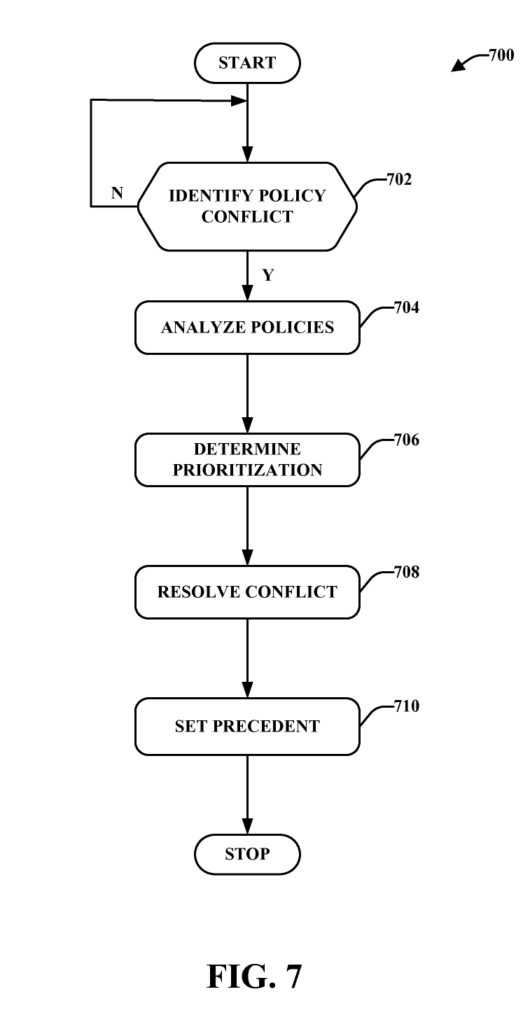

In view of the example systems described supra, methodologies that may be implemented in accordance with the disclosed subject matter will be better appreciated with reference to the flow charts of FIG. 6 and 7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Turning now to FIG. 6, an example methodology for policy enhancement is illustrated in accordance with an aspect of the present innovation. At 602, one or more service request can be received, obtained, or otherwise acquired. The service request can be acquired from a user device associated with a communication network, including but not limited to a mobile phone, laptop, GPS device, portable media device, a desktop, and so forth. In addition, the service request can include calls for most any service available via the communication network, such as voice communication, internet protocol (IP) services, text messaging, and so forth.

At 604, data related to the requested service and/or user device is obtained from the network (e.g., network data). For example, a user device can have an associated user identification that is used by the network to monitor the user's network activity, such as calls placed, network resources consumed, and so forth. As an additional example, the network data can include information such as time, date, location, and most any other information maintained or determined by the network relevant to delivery of services. At 606, one or more policies relating to the service request and/or user identification can be located, determined, or otherwise identified. For example, a quality of service policy can be located that details a guaranteed bit-rate for the user.

At 608, the service request, network data, and policies can be aggregated to determine the services available or the services to provide to the user. For example, the policies for various services can be time dependent, and the determination of available of services can account for such. At 610, a set of customized services is provided to the user based at least in part on the aggregation at 608. The customized services can include virtually any services available via a communication network. It is to be appreciated that the foregoing is but one example; and those skilled in the art will be able to readily identify additional equivalent examples.

FIG. 7 illustrates an example methodology for policy conflict resolution in accordance with an aspect of the subject innovation. At 702, one or more conflicting policies can be identified. Policy conflicts can arise under a number of situations, for example, different people within an organization (e.g., service provider) may inadvertently enter conflicting policies for a user or service. At 704, the conflicting policies are examined, investigated, or otherwise analyzed to determine the contents and details of the policy, and the source of any conflicts resulting from the policy.

At 706, the prioritization of the conflicting policies can be determined. For example, a conflict can be determined between a first policy and a second policy, as previously discussed. A prioritization value can be determined for each of the first and second policy. The prioritization value can be most any suitable indicator for assigning, ranking, or prioritizing the policies. For example, the prioritization value can be a numeric indicator based on a predetermined scale, a grade, a ranking, and so forth. In addition, the prioritization value can be associated with the policy in virtually any suitable manner, such as included in the policy, appended to the policy, a tag, metadata, etc. Additionally or alternatively, the prioritization value can be dynamically determined based on one or more features of the policy. For example, the prioritization value for each of the first and second policies can be determined based on the creator of the policy.

At 708, the conflict between one or more policies is resolved. The conflict can be resolved based on the prioritization values determined at 706. Returning to the previous example, the conflict can be resolved by applying the second policy, where the second policy has a higher prioritization value than the first policy. A precedent for resolving policy conflicts commensurate with the conflict resolved at 708 can be set. For example, a precedent can be determined that allows for future conflicts involving the first policy and second policy to be settled according to the solution determined at 708. It is to be appreciated that the foregoing represents but a single example illustrated for brevity and clarity of explanation; however, multiple equivalent techniques are possible within the scope and spirit of the subject innovation.

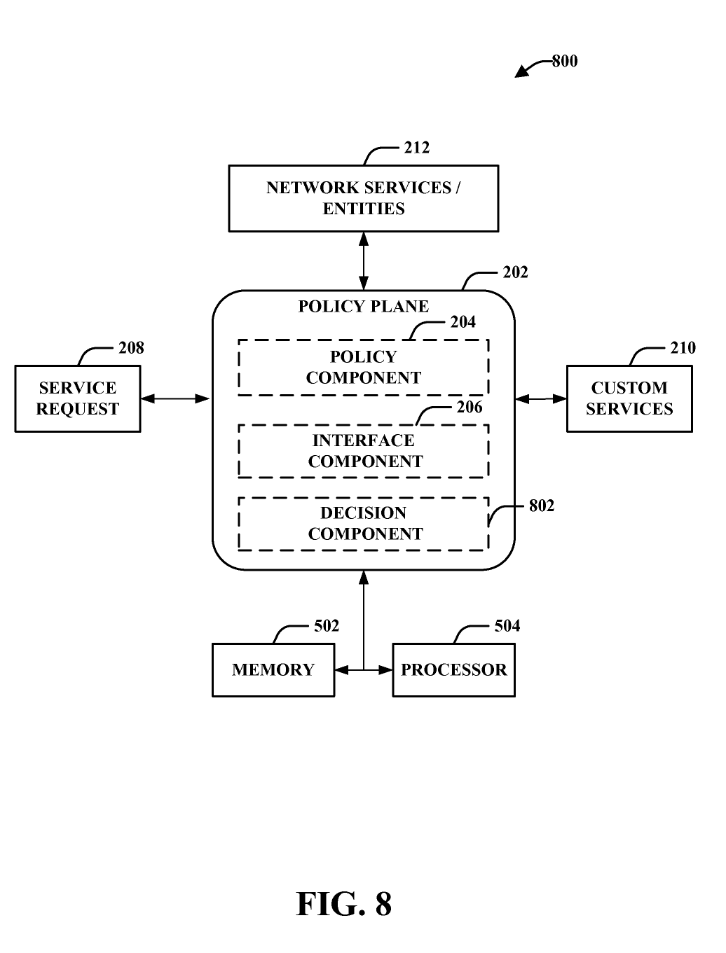

FIG. 8 illustrates a system 800 that employs a decision component 802 which facilitates automating one or more features in accordance with the subject innovation. The subject innovation (e.g., in connection with inferring) can employ various decision facilitating schemes for carrying out various aspects thereof. For example, a process for implementing a policy plane, prioritizing policies, or resolving conflicts can be facilitated via an automatic classifier system and process.

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Furthermore, inference can be based upon logical models or rules, whereby relationships between components or data are determined by an analysis of the data and drawing conclusions there from. For instance, by observing that one user interacts with a subset of other users over a network, it may be determined or inferred that this subset of users belongs to a desired social network of interest for the one user as opposed to a plurality of other users who are never or rarely interacted with.

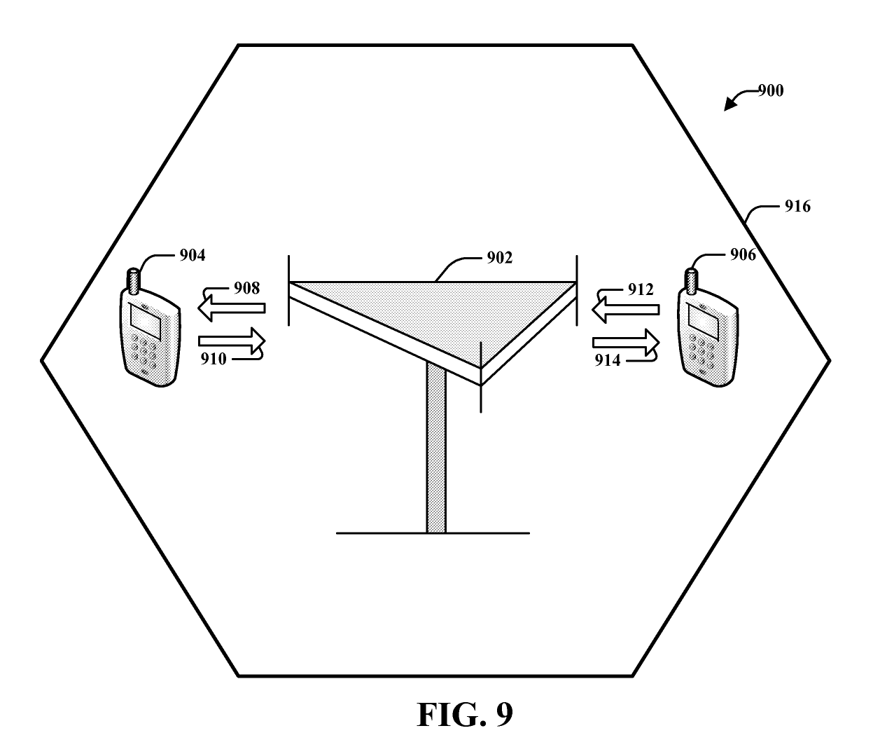

Referring back to the drawings, FIG. 9 illustrates a telecommunications network 900 in accordance with various embodiments presented herein. System 900 comprises a base station 902 that can include multiple antenna groups. For example, the base station 902 can include a plurality of antenna groups. Each antenna group can include N antennas, where N is an integer. Base station 902 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 902 can communicate with one or more mobile devices such as mobile device 904 and mobile device 906; however, it is to be appreciated that base station 902 can communicate with substantially any number of mobile devices similar to mobile devices 904 and 906. The mobile devices 904 and 906 can be, for example, cellular phones, smart phones, laptops, handheld communication devices, handheld computing devices, satellite radios, global positioning systems, PDAs, and/or any other suitable device for communicating over telecommunications network 900. As illustrated, the mobile device 904 is in communication with the base station 902, where antennas included in the base station 902 transmit data to the mobile device 904 via a forward link 908 and receive data from mobile device 904 over a reverse link 910. Similarly, mobile device 906 is in communication with the base station 902, where a set of antennas transmit data to the mobile device 906 over a forward link 912 and receive data from the mobile device 906 over a reverse link 914. In a frequency division duplex (FDD) system, forward link 908 can utilize a different frequency band than that used by reverse link 910, and forward link 912 can employ a different frequency band than that employed by reverse link 914, for example. Further, in a time division duplex (TDD) system, the forward links 908 and 912 can utilize a common frequency band with the reverse links 910 and 914.

Each group of antennas and/or the area in which they are designated to communicate can be referred to as a base station sector 916 (discussed infra). For example, antenna groups can be designed to communicate to mobile devices in a sector of the areas 916 covered by base station 902. In communication over forward links 908 and 912, the transmitting antennas of base station 902 can utilize beamforming to improve signal-to-noise ratio of forward links 908 and 912 for mobile devices 904 and 906. This can be provided by using a precoder to steer signals in desired directions, for example. Also, while base station 902 utilizes beamforming to transmit to mobile devices 904 and 906 scattered randomly through an associated coverage, mobile devices in neighboring cells can be subject to less interference as compared to a base station transmitting through a single antenna to all its mobile devices. Moreover, mobile devices 904 and 906 can communicate directly with one another using a peer-to-peer or ad hoc technology in one example.

According to an example, system 900 can be a multiple-input multiple-output (MIMO) communication system. Further, system 900 can utilize substantially any type of duplexing technique to divide communication channels (e.g., forward link, reverse link, etc.) such as FDD, TDD, and the like. Moreover, the system 900 can be a multiple-bearer system. A bearer can be a data path of defined capacity, delay, bit error rate, etc. The mobile devices 904 and 906 can each serve one or more radio bearers. The mobile devices 904 and 906 can employ uplink rate control mechanisms to manage and/or share uplink resources across the one or more radio bearers. In one example, the mobile devices 904 and 906 can utilize token bucket mechanisms to serve the radio bearers and to enforce uplink rate limitations. It is to be appreciated that the foregoing illustrates but a few example, and those skilled in the art will be able to readily identify equivalent examples. For example, the system 900 can include most any quantity of telecommunications devices.

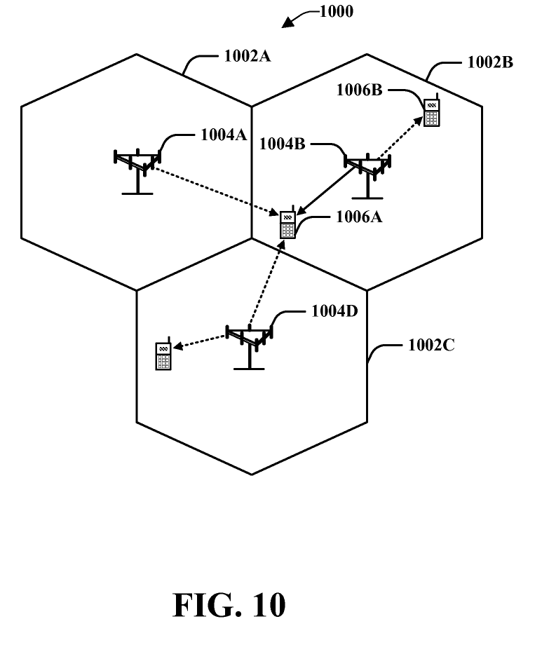

FIG. 10 illustrates an example wireless communication system 1000 in accordance with one or more aspects of the subject innovation. The wireless communication system 1000 can be support a plurality of users (e.g., mobile devices, etc.). By way of example, system 1000 provides communication for multiple cells, such as, macro cells 1002A-1002C, with each cell being serviced by a corresponding access point (AP) 1004 (such as APs 1004A-1004C). As previously discussed, each cell may be further divided into one or more sectors (e.g. to serve one or more frequencies). Various access terminals (ATs) 1006, including ATs 1006A-1006C, also known interchangeably as user equipment (UE) or mobile stations, are dispersed throughout the system. As discussed previously, each AT 1006 may communicate with one or more APs 1004 on a forward link (FL) and/or a reverse link (RL) at a given moment, depending upon whether the AT 1006 is active and whether it is in soft handoff, for example. It is to be appreciated that the wireless communication system 1000 can provide service over a large geographic region. For example, the macro cells 1002A-1002C may cover a few square acres or a few square miles.

As illustrated, the AT 1006A can be served by any of the three APs 1004A-1004C. As discussed previously, one or more policies can be employed in order to determine which AP 1004 should service the AT 1006A. For example, the AT 1006A can initiate a data communication session. A policy plane contained in the wireless communication system 1000 can receive a service request from the AT 1006A for the data communication session. The policy plane can obtain any relevant network and/or user data (e.g., time, location, user credentials, etc.), and can acquire or locate one or more relevant policies. For example, a first policy may indicate that the AT 1006A is guaranteed a certain bandwidth under their service agreement. The policy plane can determine that only the AP 1004B is presently capable of delivering the required bandwidth. Consequently, the AT 1006A will be serviced by the AP 1004B. It is to be appreciated that this is but one example illustrated for brevity and simplicity of explanation.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates network communication, comprising:
a communication network that provides communication services to a plurality of user devices; and
a policy plane included in the communication network that obtains a service request from at least one user device, and determines a set of polices to be employed by the communication network in delivering the services.

2. The system of claim 1, wherein the policy plane includes a policy component that enables at least one of creation, management, or manipulation of policies.

3. The system of claim 2, wherein the policy component includes a management component that enables the policy component to at least one of locate, create, manipulate, or organize the policies.

4. The system of claim 2, wherein the policy component includes a conflict resolution component that settles conflicts identified between one or more polices.

5. The system of claim 4, wherein the conflict resolution component settles the conflicts via prioritization.

6. The system of claim 4, wherein the conflict resolution component settles the conflicts based on at least one of a policy or a precedent.

7. The system of claim 1, wherein the policy plane includes an interface component that enables the policy plane to obtain at least one of user data, network data, and/or service agreement data.

8. The system of claim 1, wherein packet inspection can be leveraged to provide at least one of policy enforcement, or policy decisions.

9. The system of claim 1, further comprising a decision component that facilitates automating one or more features of the system.

10. A method for facilitating network communication, comprising:
acquiring at least one service request from a user;
obtaining at least one of service data, user data, or network data based on the service request;
determining at least one policy based at least in part on one of the service request, user data, service data, or network data; and
providing a set of customized services to the user by implementing the policies.

11. The method of claim 10, wherein the policies include at least one of a quality of service policy, a charging policy, a access network selection policy, a mobility selection policy, a internet protocol based domain (IMS)/circuit switched domain (CS) selection policy, a service selection policy, a privacy policy, or an identification management policy.

12. The method of claim 10, further comprising identifies conflicts between the determined polices, and resolving identified conflicts based on at least one of a set of policies, or a prioritization.

13. The method of claim 12, wherein prioritization is at least one of a hierarchy, a grade, a ranking, or a numerical indicator of primacy.

14. The method of claim 12, further comprising setting at least one precedent based on the conflict resolution, wherein the precedent is used to resolve similar conflicts.

15. The method of claim 10, wherein disparate service providers share policies associated with at least one of a user or service for the purpose of providing communication services.

16. The method of claim 10, further comprising leveraging packet inspection to provide at least one of a policy enforcement, or policy decisions.

17. The method of claim 10, further comprising automating one or more steps of the method.

18. A system facilitating network communication, comprising:
means for obtaining at least one service request from at least one of a user or a user device;
means for acquiring at least one of service data, user data, or network data based on the service request;
means for determining at least one policy based at least in part on one of the service request, user data, service data, or network data; and
means for providing a set of customized services to the user by implementing the policies.

19. The system of claim 18, wherein the policies include at least one of a quality of service policy, a charging policy, a access network selection policy, a mobility selection policy, a internet protocol based domain (IMS)/circuit switched domain (CS) selection policy, a service selection policy, a privacy policy, or an identification management policy.

20. The system of claim 18, further comprising means for determining and resolving existing conflicts between polices, wherein resolving the conflicts is based on at least one of a set of policies, or a prioritization, wherein prioritization is at least one of a hierarchy, a grade, a ranking, or a numerical indicator of primacy.
